(19) United States
(12) Patent Application Publication
(10) Pub. No.: US 2006/0223601 A1
(43) Pub. Date: Oct. 5, 2006

(54) Display device for game machine

(76) Inventor: Haruo Inoue, Tokyo (JP)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/338,837

(22) Filed: Jan. 25, 2006

(30) Foreign Application Priority Data
Apr. 1, 2005 (JP) 2005-105834

(51) Int. Cl. A63F 13/00

(52) U.S. Cl. 463/1

(57) ABSTRACT

A display device for the game machines including display bodies which display symbols and information for dividend has a first display body with a circular edge with display parts provided to a circumferential direction at the display surface classifying and displaying information about game, such as symbols, dividend information and a second display body at the end of movable support arm provided in the backside of the first display body so as to always be exposed from the edge of the first display body and being capable of rotating and moving along the edge of the first display body through the movable support arm, the second display body having a display part which can indicate information about game uniquely. Therefore, the second display body may be simplified, and it has a powerful impact. In addition, it enables the player to understand the revolving mode (speed, direction of revolving) of the second display body easily, and it is easy to install in the case.

### CROSS REFERENCE TO RELATED APPLICATIONS

This application is based on Japanese Patent Application 2005-105834 filed on Apr. 1, 2005, upon which priority is claimed.

### BACKGROUND OF THE INVENTION

1. Field of the Invention

The present invention relates generally to a display device for game machines, and more particularly such a display device, capable of being used for determining the presence or absence of a prize, continuing the game, determining the dividend and the like by a combination with a first display body which is installed into the body of the game machine, indicating symbols, information for dividend and the like and a second display body which indicates information for dividend including symbols and dividend cover.

2. Description of the Prior Art

Japanese Laid-Open Patent Publication No. 2004-222779 discloses a display device for game machines including a first symbol display means having a large symbol display surface which is formed in the shape of a matrix; a second symbol display means on which is displayed small symbol display surface from the edge of the symbol display surface, corresponding to one of symbols (one piece); and drive means for the first and second symbol display means and control means controlling each drive means.

For the above condition, after the flow display and the stop display of symbols by the symbol display parts of a big inside symbol display surface are carried out, a new line of winning a prize can be decided by the combination of symbol of the large symbol display surface and symbol of the small symbol display surface by moving the small outside symbol display surface along the surrounding edge of the large symbol display surface.

However, for the invention described in the reference, because the small (second) symbol display surface is moved respectively in the right and left directions or upward and downward individually along the surrounding edges of the large (first) symbol display surface, the amount of the movement is little (up to three pieces in the disclosed embodiments). In addition, when the second symbol display surface is enabled to move along the entire edge part of the first symbol display surface, the drive means and positional detection means for the right and left and the upper and lower are necessary respectively. In fact, there is a fault that the device is complicated because a lot of drive sources concerning the second symbol display means, careers, positional detection means an the like when the small symbol display surface is moved to the circumferential edge of the large symbol display surface.

In addition, Japanese Laid-Open Patent Publication No. 2004-283233 discloses that a game machine which includes a main display means with at least transparent part for one symbol, having a plurality of display bodies; a sub-display means which is arranged to be concealed in a back side of the main display means, having a sub-display body capable of being viewed through the transparent part; drive means for the main display means and sub-display means; means for controlling each drive means; display bodies of the main display means which are formed in the shape a ring, facing the display surface concentrically (radial direction); and a sub-display body of the sub-display means which is defined by a revolving reel which is provided at a front side of a circular support plate.

For the above-mentioned composition, the sub-display body rotates and moves at the back portion of the display body in the main display means. When the predetermined condition is approved (for example, the sub-display body stop at the back side of the transparent part of the main display body), the sub-display body is further allowed to rotate (uncertain display), and it makes the symbol of main-display body and sub-display body to combine each other.

However, for the invention described in the reference document 2, it lacks player attraction because the sub-display body is always positioned on the other side of the main display means, and the rotation of the sub-display body is not understood easily by the player. In addition, the main display body should be divided into places for symbols and transparent parts (blank symbol) because the sub-display body can be seen through the transparent part of the main display body. Furthermore, it is necessary to extend for a long to the radius direction of the display body in order to position the cylindrical sub-display body to the transparent part of the display bodies. In fact, the main display body is complicated a little, and the sub-display body needs to be constituted in the shape of a long pipe.

### SUMMARY OF THE INVENTION

Accordingly, it is an object of the present invention to provide a display device for game machines that overcome the problem of the devices disclosed in the references. It is another object of the present invention to provide a display device for game machines that can be installed the devised subject member into the case easily. It is a further object of the present invention to provide a display device for game machines that can raise the hopes of the players for the games by the combination of the symbol in the first display body and symbol of the second display body allowing the player to become more excited.

The display device for game machines in the present invention includes display bodies which display symbols and information for dividend; a plurality of means for driving the display body individually through a base support member; means for controlling the drive means; the display body further including a first display body with a circular edge thereof, having a plurality of display parts provided in a circumferential direction at the display surface, classifying and displaying information about game, such as symbols, dividend information; and a second display body provided at the end of movable support arm provided in the backside of the first display body so as to always be exposed from the edge part of the first display body, capable of rotating and moving along the edge part of the first display body through the movable support arm, and having a display part which can indicate information about the game uncertainly and uniquely.

For the above-mentioned composition, the display surfaces of the first display body and second display body are provided to face verticality. In addition, the display surface of the second display body is exposed from the edge part of the first display body through a third drive motor which is fixed to the end part of the movable support arm.

The term “the end part is formed in the shape of a circle” includes the case (polygon which cut the arc portion) that the impression of being circular is visually perceived.

### BRIEF DESCRIPTION OF THE DRAWINGS

FIGS. 1 to 5 are illustrated in explanation views showing the best mode of one embodiment of the present invention FIGS. 6 and 7 are illustrated in explanation view showing a second embodiment of the present invention.

FIG. 1 is a schematic explanation view showing a condition of an embodiment of the present invention;

FIG. 2 is an exploded perspective view showing the main display assembly including the first display body, second display body, third drive motor, drive shaft, support member and the like;

FIG. 3 is an exploded perspective view of means for driving without a drive shaft;

FIG. 4 is a schematic elevation view, in section, showing the drive assembly;

FIG. 5 is an elevation view from the front side;

FIG. 6 is a elevation explanation view, in section, showing the drive assembly of a second embodiment of the present invention; and

FIG. 7 is an explanation view from the front side of the structure in FIG. 6.

### DETAILED DESCRIPTION OF THE INVENTION

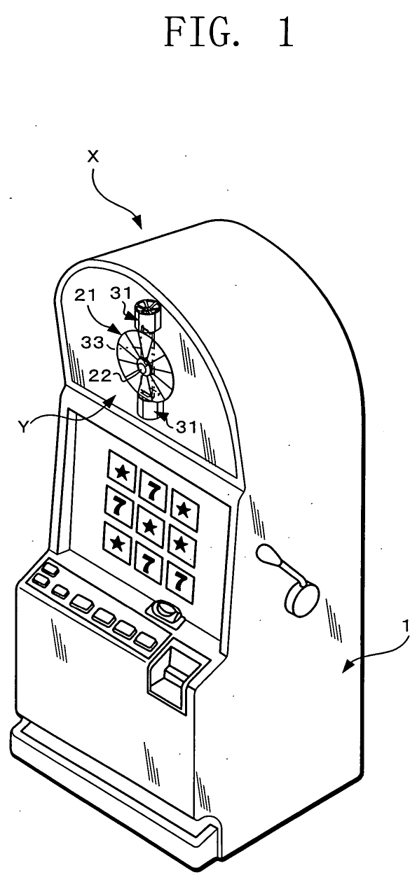

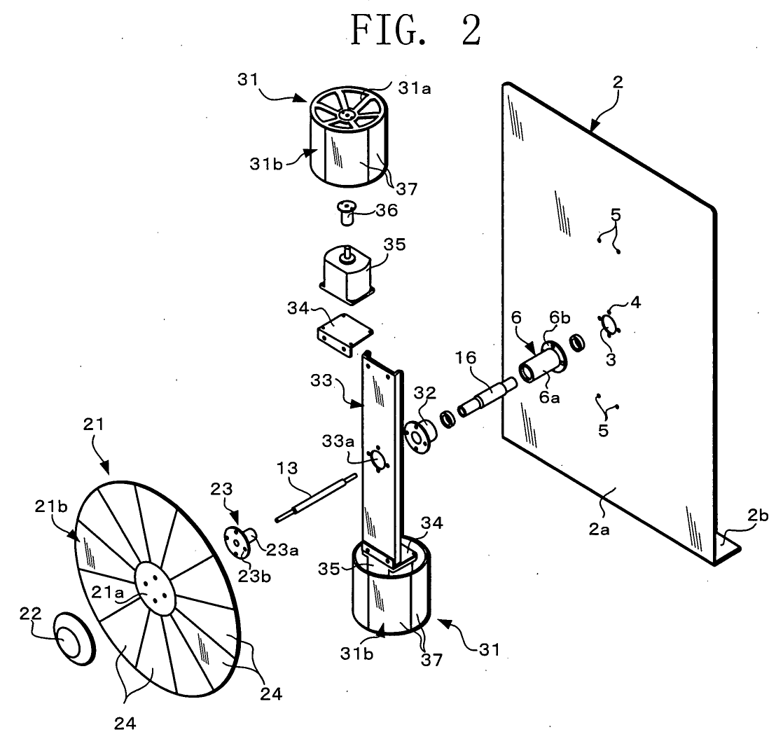

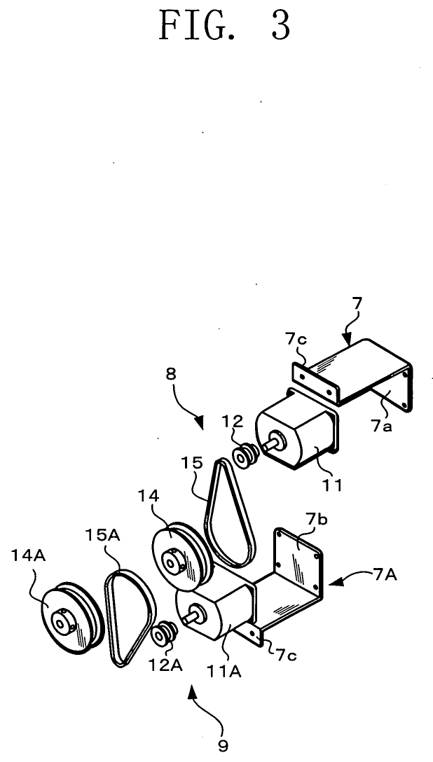

FIG. 1 is a schematic explanation view showing one embodiment of the present invention. In FIG. 1, reference mark X is an example (slot machine) of the game machines. Reference numeral 1 is a case, setting a display device Y at an upper part side of the case 1. In addition, although unrelated to the specific requirements for this invention, the game machine X may be equipped with members required in order to perform game(s), such as a coin saucer, control panel, matrix-shaped display window and control lever, which is not numbered. Although specific components of the present invention are explained individually hereafter with reference to FIG. 2, FIG. 3 and so on, the explanation about a details-matter is omitted as much as possible.

Reference numeral 2 is a support member with a large size, fixing into the case 1 of the game machine X. The support member 2, as shown in FIG. 2, includes a broad support plate part 2a formed in the shape of a rectangle and an end plate part 2b which is formed with bending a lower end part of the support plate part 2a. The support member 2 is a member used as a base to support member 6, 7, 7A having other support functions. Although not illustrated especially, two or more attachment holes for the adherence means are formed in the above-mentioned the end plate part 2b, for example, and the support member 2 is fixed in a case 1 through the attachment holes and an adherence implement. Although the support member 2 is formed in the shape of a cross-sectional L type in this embodiment, the form and quality of the material are not limited especially. Reference numeral 3 is a shaft hole formed in the central part of the support plate part 2a. Reference numeral 4 are first attachment small holes formed adjacent the shaft hole 3. Reference numeral 5 are second attachment small holes formed in the upper and lower part of the support plate part 2a respectively.

Reference numeral 6 is a support member shape, which is formed in the shape of a pipe, fixed to a level state by suitable means such as screws, not illustrated, to the front side of the base support member 2. The support member 6 is used in order to support the drive shaft 16.

In addition, the support member 6 further includes an engaging part 6a which engages with the drive shaft and a flange part 6b which are arranged circularly at an one end portion of the engaging part 6a, and a plurality of small through holes which correspond to the first attachment small hole 4 are formed in the flange part 6b.

In addition, reference numerals 7, 7A that are shown in FIG. 3 are a plurality of support member, which are formed in the shape of a plate, being fixed to the back portion of the support member 2 as a base through an attachment which is not shown in the figure. The support members 7, 7A may be generally z-shaped or channel shaped in cross section, with flanges for easy attachment to support plate 2 and for mounting drive motors as explained below.

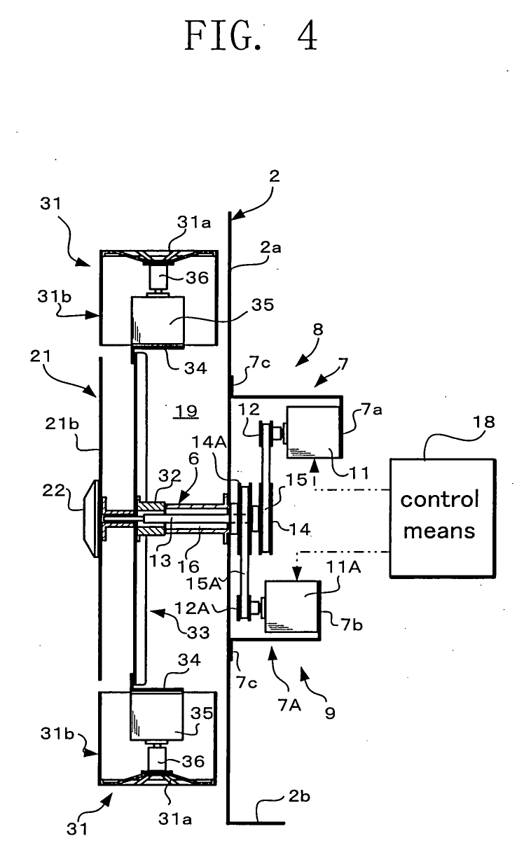

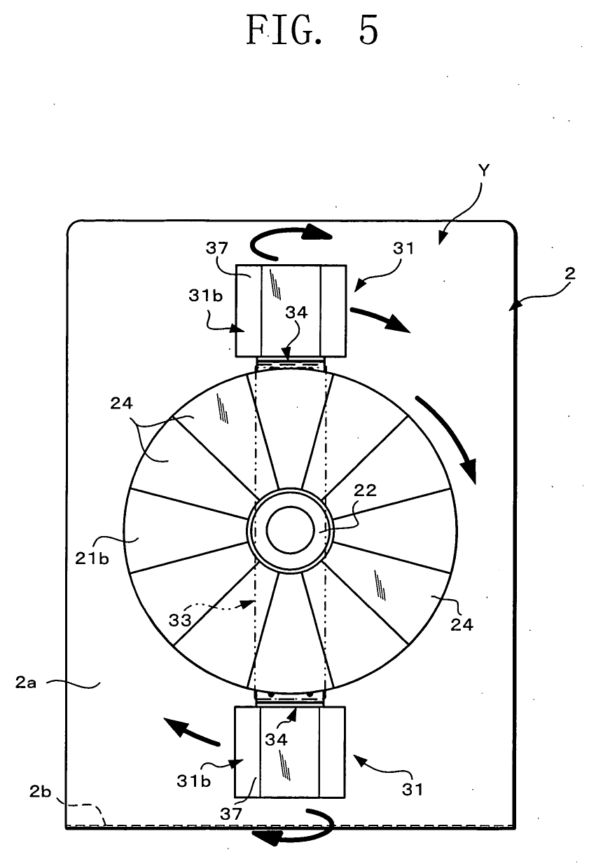

Referring to FIG. 4, a first drive motor 11 is fixed inside a projected end plate or flange 7a of the upper support member 7 at a horizontal direction. In addition, a second drive motor 11A is fixed inside a projected end plate or flange 7b of the lower support member 7A between the support members 7, 7A. Rear flanges 7c, 7c of the upper and lower support member 7, 7A are fixed to the back surface of the support member 2.

In addition, in this specification, the support member 2 and other support member 6, 7, 7A are explained separately as a matter of convenience, these support member 2, 6, 7 and 7A is make up the main support assembly.

The drive means in this embodiment includes a drive means 8 for the first display body and a drive means 9 for the second display body. FIG. 3 illustrates an exploded state for the drive means 8 and 9 without the drive shalt, and FIG. 4 illustrates the assembled state for the drive means 8 and 9.

The drive means 8 for the first display body further includes a first drive motor 11 which is fixed horizontally to projected end plate part 7a of the upper support member 7; a small drive pulley 12 fixed to an output shaft of the drive motor 11; a large driven pulley 14 connected with an inner end part of a first drive shaft 13 (transmission shaft) which penetrates the support members 2 and 6; and a transfer belt 15 which is provided between the pulleys.

The drive means 9 for the first display body further includes a drive motor 11A which is fixed horizontally to a projected end plate part 7b of the upper support member 7A; a small drive pulley 12A fixed to an output shaft of the drive motor 11A; a large driven pulley 14A connected with an inner end part of a second drive shaft 16 (transmission shalt) which penetrates the support members 2 and 6; and a transfer belt 15A which is provided between the pulleys.

Therefore, in this embodiment, the drive means 8 for the first display body and drive means 9 for the second display body are the same composition, and they are attached to one support member 2, 6 integrally (as one unit). In addition, when the drive means 8, 9 are combined, the necessary ways, such that the shaft end part is worked upon angle shaft section or angle sleeve part; the bearing is suitably prepared and the drive shaft rotates smoothly; and it is fixed with the adherence implement, are implemented. In addition, the power transfer means 15 and 15A for the display body is not limited to the transfer belt in this embodiment, and it may be used a gear transfer mechanism. In addition, the position detection means for the drive shaft is provided as the same as the conventional technology suitably.

Reference numeral 18 is means for controlling the drive motors in the drive means respectively. The control means 18 is installed into the case 1 of the game machine X suitably. In addition, it may be provided at the backside of the support member 2 corresponding to the design.

Since the concrete modes of the input part electrically connected with the control means 18, memory part (RAM, ROM), game software (the data structure of game and flow of processing) which are stored in the memory part, position detection part for drive shaft and output part etc. are not requirements which limit invention, the drawings and detailed explanation are omitted.

The example of the processing of the control means 18 is explained briefly here. The control means 18 will start the first drive motor 11 based on instructions of the execution program stored in ROM. Next, the control means 18 starts the second drive motor 11A when the first drive motor 11 is stopped and it agrees on predetermined conditions. After that, the control means 18 stops the second drive motor 11A, starts a third drive motor attached to the end of a movable support arm and stops it.

Of course, when the control means 18 allows starting and stopping each drive motor, the control means 18 accesses the memory part and gets information from the memory part. In addition, it performs the game based on each information such as random number generation part, stop symbol determination part, winning-a-prize determination part and position detection part for the drive shaft.

The display device is explained again. As shown in FIG. 2, the first display body 21 in this embodiment is formed in the shape of a disc, and a second display body 31 is formed in the shape of a sleeve (it is called “revolving reel” typically). Therefore, the end part of the first display body 21 is formed in the shape of a circle. The term “end part which is formed in the shape of a circle” is intended to include the shape of a polygon such as a pentagon, hexagon, octagon, dodecagon, for example having a generally arcuate or circular outer periphery.

The first display body 21 is provided at the tip of the first drive shaft 13 through the singular number or two or more connection member 22 and 23 so as to intersect perpendicularly with first drive shaft 13, at a predetermined space 19 in front of the base support member 2. On the other hand, the connection member 23 has a flange 23b having an attachment hole for the above-mentioned insertion pins, formed in the end part of a cylindrical part 23a.

In this embodiment, a center part 21 a of the first display body 21 is positioned in the shape of a sandwich between the connection member 22 in the front side, having a decoration function and the cylindrical connection member 23 in the back side, and it is suitably fixed to the tip part of the first drive shaft 11.

The first display body 21 has a display surface 21b, which is formed in the shape of a ring, which is positioned at a place facing the player. In addition, a plurality of display windows or parts 24 are divided radially to a circumferential direction of the display surface 21b, displaying information for the game including symbols and dividend information.

Information including characters, numbers, sign and patterns corresponding to the content of the game is related to the display part 24 or information is displayed. Of course, one part of the display part 24 can be made as a transparent area like the description in the reference document.

In addition, second display body 31 is supported so as to project from the periphery of the first display body 21 through an engagement shaft 32 formed in the shape of a sleeve, a movable support arm 33 formed in the shape of a long plate, a motor attachment plate 34 fixed to the end part of the movable support arm 33, a third drive motor 35 and a connection means 36 fixed to the output shaft of the third drive motor 35.

The second display body 31 in this embodiment is defined by the revolving reel as described above so that a display surface 31b of the body portion connected with a radial framework part 31a has information for the game which combines with symbol and dividend of the first display body 21 or information may be displayed. Therefore, the display surface 31b as the body portion is also classified as a display parts 37, such as lose, win symbol, re-rotation for example, in the circumferential direction, corresponding to the contents of game equally.

The second display body 31 is provided at the end of the movable support arm 33 provided at the backside of the first display body so as to always be exposed from the edge of the first display body. For the length of the movable support arm 33, that the length of the support arm 33 is longer than the diameter of the first display body 21 is not a specific requirement. However, the length of the movable support arm 33 is preferably the same as or slightly greater than the diameter of the first display body 21. In this embodiment, since the third drive motor 35 projects from the edge part of the first display body 21 through the motor attachment plate 34 at the end portion of the movable support arm 33, the second display body 31 having the third drive motor 35 mounted therein always projects from the edge part of the first display body.

In addition, the second display body 31 rotates and moves along the edge part of the first display body 21 through the rotation of the movable support arm 33 having the center hole 33a for the first drive shaft 13 provided at a center portion thereof.

In addition, with the support member 2 as the basic point, the forward position of the movable support arm 33 is determined by the forward support member 6 fixed in the front of base support member 2, the engagement shaft 32 which slides rotatably to the tip portion of the forward support member 6 and fixed to the back surface of the movable support arm 33 through the fixation device, and the second drive shaft 16 which fits integrally to the shaft 32 and passes through the forward support member 6.

On the other hand, with the movable support arm 33 as the basic point, the forward position of the first display body 21 is determined by the amount of projection of the first drive shaft 13 which projects from the center hole 33a of the movable support arm 33.

In this embodiment, as shown in FIG. 4, the display surfaces 21b of the first display body 21 and the display surface 31b of the second display body are provided is set at a predetermined size of each member so as to face verticality (so as to not protrude the display body 31 from the display surface 21b). In this way, when the first display body 21 and second display body 31 are defined by a mechanical revolving body, it is possible to provide a transparent protection cover in front of the second display body 31 easily at least.

For each embodiment of the present invention, when the second display body is defined by a mechanical revolving body, it may be formed in the shape of a revolving reel, plate and ball. A single or plural second display bodies may be provided. In addition, the first display body may be an electronic display device or mechanical reel, and the second display body may be an electronic display device or mechanical reel. Furthermore, the present invention may be manufactured as “usage invention” by adding common knowledge of one skilled in the art disclosed in the reference documents 1 and 2.

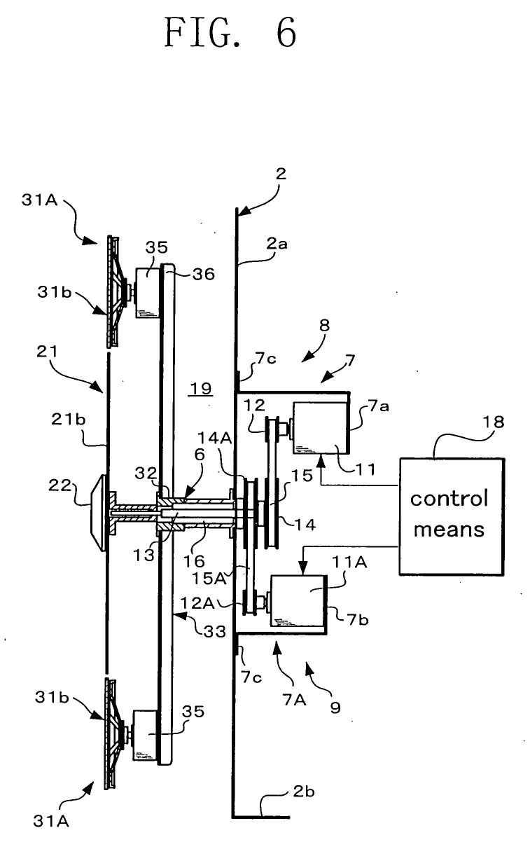

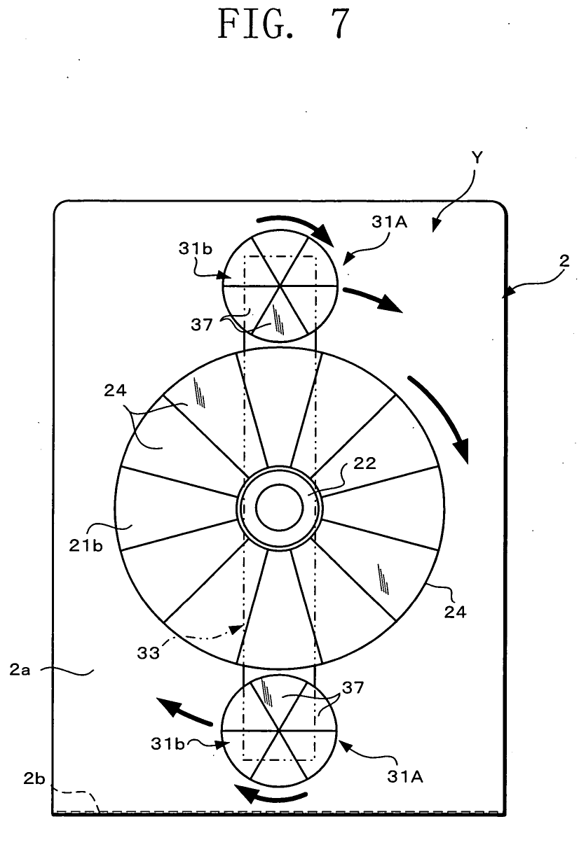

FIGS. 6 and 7 illustrate an example of design change of the first embodiment (it is called “second embodiment” as a matter of convenience, and through the embodiments, like components are denoted by like numerals as of the first embodiment and will not be further explained in great detail.

The second display body 31 in the first embodiment is defined by the revolving reel; on the other hand, the second display body 31A in the second embodiment is formed in the shape of a disc. Therefore, the display surface 31b of the second display body 31A is formed in the shape of a circle as the same as the first display body 21 in the first embodiment. Therefore, the display part 37 is divided radially to a circumferential direction of the display surface 31b, displaying information for the game including symbol, dividend information. Information including characters, numbers, sign and patterns corresponding to the content of the game is related to the display part 37 or information is displayed.

In this way, although the some parts are changed the design such that the third drive motor 35 is faced sideways, the second display body 31A is formed in the shape of a disc, the motor attachment plate is not used and the movable support arm is elongated, the second embodiment has similar advantages to that according to the first embodiment.

As set forth above, the advantages of the invention are as follows:

(1) The second display body may be simplified. In other words, compared with the prior art device, above, since the second display body moves along the edge part of the first display body in a circumferential direction, the number of the drive source, career, position detection means about the second display body may be simplified. In addition, the size of the second display body may be used as one of symbol (one piece) at least as the same as the reference document 1.

(2) Since the second display body always projects from the edge of the first display body, it has a powerful image, it enables the player to easily understand the revolving mode (speed, direction of revolving) of the second display body.

(3) Since the first display body, second display body, movable support arm, drive means are attached to the one base support member as an unit, it is easy to install in the case. Therefore, it can improve operating efficiency of manufacturing.

(4) By combination of symbols in the first display body and second display body, it can raise the hopes of the player, such as wins and losses of the game, continuation of the game, high dividend.

(5) When the first and second display bodies are the mechanical revolving body, it is possible to provide a transparent protection cover in front of the second display body easily at least.

The foregoing relates to a preferred exemplary embodiment of the invention, it being understood that other variants and embodiments thereof are possible within the spirit and scope of the invention, the latter being defined by the appended claims.

1-8. (canceled)

9. A display device for game machines, comprising
a plurality of display bodies which display symbols and information for dividend;
a plurality of drive means for driving said display bodies individually through a base support member;
means for controlling said drive means;
said display body further including a first display body with a circular edge part thereof, having a plurality of display areas provided to a circumferential direction to a display surface, classifying and displaying information including symbols and dividend information about the game; and
a second display body provided at an end part of a movable support arm which is provided at a backside of said first display body so as to always be exposed from said edge part of the first display body, capable of rotating and moving along said edge part of said first display body through said movable support arm, and having a display part which indicates information about the game.

10. The display device for game machines according to claim 9, wherein said display surfaces of said first display body and second display body are provided to face verticality.

11. The display device for game machines according to claim 9, wherein said display surfaces of said second display body is exposed from said edge part of said first display body through a third drive motor which is fixed to said end part of said movable support arm.

12. The display device for game machines according to claim 10, wherein said display surfaces of said second display body is exposed from said edge part of said first display body through a third drive motor which is fixed to said end part of said movable support arm.

13. The display device for game machines according to claim 9, wherein said first display body has a drive shaft which is supported by said base support member and which passes through a drive shaft, which is formed in the shape of a pipe, of said second display body, and wherein said drive means for said first and second display body is attached at a back surface of said base support member.

14. The display device for game machines according to claim 10, wherein said first display body has a drive shaft which is supported by said base support member and which passes through a drive shaft, which is formed in the shape of a pipe, of said second display body, and wherein said drive means for said first and second display body is attached at a back surface of said base support member.

15. The display device for game machines according to claim 11, wherein said first display body has a drive shaft which is supported by said base support member and which passes through a drive shaft, which is formed in the shape of a pipe, of said second display body, and wherein said drive means for said first and second display body is attached at a back surface of said base support member.

16. The display device for game machines according to claim 9, wherein said second display body is formed in the shape of one of a revolving reel, disc and ball.

17. The display device for game machines according to claim 10, wherein said second display body is formed in the shape of one of a revolving reel, disc and ball.

18. The display device for game machines according to claim 11, wherein said second display body is formed in the shape of one of a revolving reel, disc and ball.

19. The display device for game machines according to claim 13, wherein said second display body is formed in the shape of one of a revolving reel, disc and ball.

20. The display device for game machines according to claim 9, wherein each said component is supported on said base support member as an assembled unit.

21. The display device for game machines according to claim 9, wherein said first display body is either an electrical display device or a mechanical reel.

22. The display device for game machines according to claim 10, wherein said first display body is either an electrical display device or a mechanical reel.

23. The display device for game machines according to claim 11, wherein said first display body is either an electrical display device or a mechanical reel.

24. The display device for game machines according to claim 13, wherein said first display body is either an electrical display device or a mechanical reel.

25. The display device for game machines according to claim 9, wherein said second display body is either an electrical display device or a mechanical reel.

26. The display device for game machines according to claim 10, wherein said second display body is either an electrical display device or a mechanical reel.

27. The display device for game machines according to claim 11, wherein said second display body is either an electrical display device or a mechanical reel.

28. The display device for game machines according to claim 13, wherein said second display body is either an electrical display device or a mechanical reel.
